(19) United States
(12) Patent Application Publication
(10) Pub. No.: US 2024/0175975 A1
(43) Pub. Date: May 30, 2024

(54) OUTDOOR SOUND SOURCE IDENTIFICATION

(71) Applicant: Crystal Instruments Corporation, Santa Clara, CA (US)

(72) Inventor: James Q. Zhuge, Palo Alto, CA (US)

(73) Assignee: Crystal Instruments Corporation, Santa Clara, CA (US)

(21) Appl. No.: 18/119,801

(22) Filed: Mar. 9, 2023

Related U.S. Application Data
(60) Provisional application No. 63/428,186, filed on Nov. 28, 2022.

(51) Int. Cl. G01S 5/22; H04R 1/40; H04R 3/00; H04R 3/04

(52) U.S. Cl. CPC G01S 5/22; H04R 1/406; H04R 3/005; H04R 3/04; H04R 2201/401; H04R 2410/01; H04R 2420/07

(57) ABSTRACT

Acoustic events are localized using sound data from spatially distributed data acquisition units, by performing frequency domain cross-spectra calculations and noise removal before transforming back to a time domain for pairwise delay estimations. The units record sound along with unit locations and a reference time base obtained from a global positioning system or related reference, which allows time stamps to be applied to blocks of acoustic data with sub-microsecond accuracy. The acoustic data and time stamps are transferred to a central computer for processing, where received data is first transformed into a frequency domain, then multiple pairs of the transformed data are subject to cross-spectra computation. Any noise is reduced in the frequency domain. The cross-spectrum computations are transformed back into the time domain as cross-correlation functions for time delay estimation between acoustic events. From those estimated time delays and the relative positions of pairs of data acquisition units, the sound source can be determined to greater accuracy than previously possible.

### CROSS-REFERENCE TO RELATED APPLICATION

This application claims priority under 35 U.S.C. 119 (e) from prior U.S. Provisional Application 63/428,186, filed Nov. 28, 2022.

### TECHNICAL FIELD

The present application relates to sound localization from analysis of acoustic signals gathered by distributed sensor units, and more specifically to the use of acoustic data that has been timestamped via GPS or a similar satellite system.

### BACKGROUND ART

Sound source location identification has a wide range of potential applications. One example is the pinpointing and tracking of the direction and location of animals (wolves, elephants, dolphins, etc.) in the wild over distances extending from a few hundred meters to many kilometers. Another would be to detect and quickly locate the source of gunshots by law enforcement or by soldiers in a combat environment. It could also be applied to aircraft engine or propeller noise or sonic booms over longer distances, or even to sonar detection and location of underwater vehicles. The location of very low frequency sounds (e.g., from earthquakes, volcanic eruptions, nuclear weapon explosions) at global distances.

In “Sound Source Localization in Wide-range Outdoor Environment Using Distributed Sensor Network”, IEEE Sensors PP (99): 1-1 (October 2019), Faraji etc. discussed a GPS based sound source identification data acquisition (DAQ) system that is of great interest. This device is equipped with an array of multiple microphones, ADC (Analog to Digital Converter), a microprocessor, an SD card to store the measurement data. The GPS is used for two purposes, one to determine the location of each DAQ unit and the other to provide a 1 pps (pulse per, second) signal to the microprocessor so that measured acoustic signals can be timed stamped. When the technology is deployed, multiple DAQ units (sensor nodes) are spread over a range of interest. The algorithm is based on time domain detection and statistical analysis with a method called Fuzzy beliefs. Specifically, each DAQ unit or node determines a sound source direction using a delay and sum beamforming (DSB) method, then the directions obtained from multiple DAQ units or nodes are “fuzzified” and fused to determine a most probable sound source location. This technology can successfully detect the source location in an outdoor range such as 240×160×80 m³, with a mean distance error of 6.0 meters.

The technology proposed above has a couple of drawbacks. First, the whole process is based on the time domain signal processing and statistical analysis. The accuracy of time domain signal processing is much lower than those in the frequency domain because in time domain the signals are easier to get contaminated by noise or unexpected interference signals. In order to increase the accuracy of measurement, the authors adopted multiple microphones on a DAQ and multiple DAQs in the field. In a typical example, 8 sensors are used on each DAQ while 8 DAQs are deployed to construct the complete measurement system. Totally 64 microphones are used in order to make the complete measurement. By having many more redundant measurement and statistic processing, the system is able to achieve high accuracy of location determination. However, the total cost and complexity of system is very high.

In U.S. Pat. Nos. 6,847,587; 7,586,812; 7,710,278; 7,750,814; and 8,063,773, Patterson, Baxter, Holmes, and Fisher of ShotSpotter, Inc. described versions of a system that comprise multiple radio-networked DAQs, each equipped with a microphone, ADC, CPU, GPS time source, power supply and network interface. A time-domain based processing method using envelope analysis method is disclosed. The signal processing is applied to the data of each of microphones separately. There is no signal processing dealing with the cross terms between multiple channels such as cross spectral analysis. A drawback of this method is that it potentially may have high false rate of alarms. Processing methods based on the envelope of a time domain signal has less capability to differentiate the sound with different signatures comparing to a frequency domain processing method such as FRF (Frequency Response Function) or cross spectra. U.S. Pat. Nos. 7,266,045 and 8,036,065 were granted to Baxter and Fisher for a wearable configuration of gunshot DAQ for targeting in a battlefield or combat environment. The configuration is a distributed network like that in the first set of patents with radio wireless communication with other wearable DAQs in the field.

In U.S. Pat. No. 5,973,998, Showen and Dunham disclose a method that simply use cross-correlation method to determine the location of sound source. The algorithm of this method has been in the textbook for many years. Cross correlation is a reliable way to detect the time delay of two response signals coming from the same source. Based on the delay calculated and the estimated speed of sound, the location of sound source can be estimated. This method has much higher accuracy than those described by Fisher and Baxter. The data acquisition system is a centralized data acquisition structure based on a computer. Multiple sensors can be connected to the computer where the data are digitized. The cable length for each sensor can be as long as a few thousand feet but no more. Showen and Dunham also teach that cross-correlation methods between pairs of sound on different sensors should be used because the cross-correlation technique helps to weed out a false (i.e., non-correlating) noise.

In U.S. Patent Application Publication 2021/0289168 of Glückert et al., a combined visual and acoustic monitoring system provides event detection, localization, and classification. An event source is spatially localized (at least directionally and preferably with distance information) by the system using time information, then associated with corresponding video information, and the type of event is classified. For the acoustic localization, a multi-channel microphone array continuously captures audio information and provides a timestamp. An acoustic localization algorithm determines the localization of a sound event by determining differences in arrival times at the microphone array (both primary signals and any corresponding secondary echo signals, i.e., reflections, multi-reflections, or resonance effects).

There are roughly two main categories of sound localization hardware. One involves a distributed network of multiple separate DAQs that are geographically spread over the range of interest. Each DAQ has its own microphones, ADCs, CPU, display panel, control panel, data storage, and communication interface. They communicate with each other through a wireless network. Since each DAQ has its own sampling clock, which will necessarily deviate from each other, the localization algorithms are based on single channel signal processing in the time domain, such as envelope analysis, edge detection or statistics analysis. The second category of DAQ hardware configuration involves a centralized data acquisition system of physically connected sensors. The microphones or hydrophones or accelerometer sensors are connected to the input channels of the centralized data acquisition system, where multiple ADCs are installed. The ADCs of all input channels are sampled simultaneously on the same clock with synchronous sampling rate. Because of this, cross-correlation signal processing can be used. The cross-correlation function can be derived from the cross-spectrum in the frequency domain. The time delays can be calculated based on that cross-correlation of pairwise inputs. Based on multiple time delays between sensors, the location can be accurately estimated. However, this configuration is possible only where reliable hardwired connections of the sensors can be constructed. From a cost and deployment standpoint, the distributed architecture, even if somewhat less accurate, is more economical and practical.

Ideally, it would be desirable to have a distributed architecture of the sensor network, while at the same time, one where cross-terms such as a cross-correction function or cross-spectrum can be calculated. An ideal hardware system shall consist multiple DAQs that are not hardwire connected. Each DAQ is equipped with microphone and data processing unit. Hardware should be ruggedized, easy to install, small in size and battery powered. When real-time result is needed instantaneously, the measured data shall be transmitted to a designated processor wirelessly to compute the cross-terms between each pair of measurements or an array of measurements. Sound source location should be shown up on a 2D or 3D map within seconds of event happening.

### SUMMARY DISCLOSURE

The present invention estimates sound source location using the association of accurate time stamps with groups of sampled acoustic data recorded by multiple separate data acquisition (DAQ) units and performing frequency domain cross-spectra calculations and noise removal before transforming back to a time domain for pairwise delay estimations. DAQ microphones measure analog sound signals that are converted to digital format with analog-to-digital converters (ADCs). Both the DAQ locations and a reference time base are based on satellite ground positioning system (GPS) or related reference, which allows time stamps to be applied to blocks of ADC-sampled acoustic data. The recorded digital acoustic data and time stamps are transferred to a central computer for processing. The acoustic data is transformed into the frequency domain, then multiple pairs of the transformed data are subject to cross-spectra computation. Any noise is removed or substantially reduced in the frequency domain. The cross-spectrum computations for the multiple pairs of data are transformed back into time domain for estimation of time delays between measurements of acoustic signals. From those estimated time delays, and the relative positions of the pairs of DAQ microphones, the sound source location can be estimated to greater accuracy than previously possible. The location can be displayed on a map or geographic coordinates can be otherwise communicated to an interested user.

### BRIEF DESCRIPTION OF THE DRAWINGS

FIG. 1 is a schematic diagram illustrating pairwise sound source localization for two microphones with an inset time graph of microphone signals.

FIG. 2 is a sound waveform graph of acoustic pressure (in Pascals) versus time (in seconds) with three overlaid channels of a single transient acoustic event (such a gunshot).

FIGS. 3A, 3B and 3C are graphs of three pairwise cross-correlation functions for the three channels of FIG. 2.

FIG. 4 is a graph of two overlaid sound waveforms of a relatively smaller transient signal and a relatively louder periodic signal representing noise (unwanted signal).

FIG. 5 is a graph of cross-spectrum amplitude in the frequency domain for the two overlaid sound waveforms in FIG. 4.

FIG. 6 is a schematic block diagram of a set of data acquisition (DAQ) units in a system that measures sound signals and uses GPS satellites to apply accurate time stamps to recorded acoustic data.

FIG. 7 is a schematic block diagram showing components of a DAQ unit like those used in FIG. 6.

FIGS. 8 and 9 are respective block diagrams illustrating two ways to transfer recorded data from multiple DAQs to a central computer or cloud server.

FIG. 10 is a flow diagram showing steps of the sound source localization method of the present invention.

FIG. 11 is a schematic time graph of two series of measured and sampled data at a nominal sampling period dT.

FIG. 12 is a flow diagram showing steps for determining a time stamping interval that meets required accuracy for cross-spectrum computations in view of possible clock drift.

FIGS. 13 and 14 are representative maps, a first on a larger geographic scale and the second on a more local scale, showing locations for a set of three DAQ units and the location of a sound source.

### DETAILED DESCRIPTION

### Use Cross-Correlation to Estimate the Time Delay

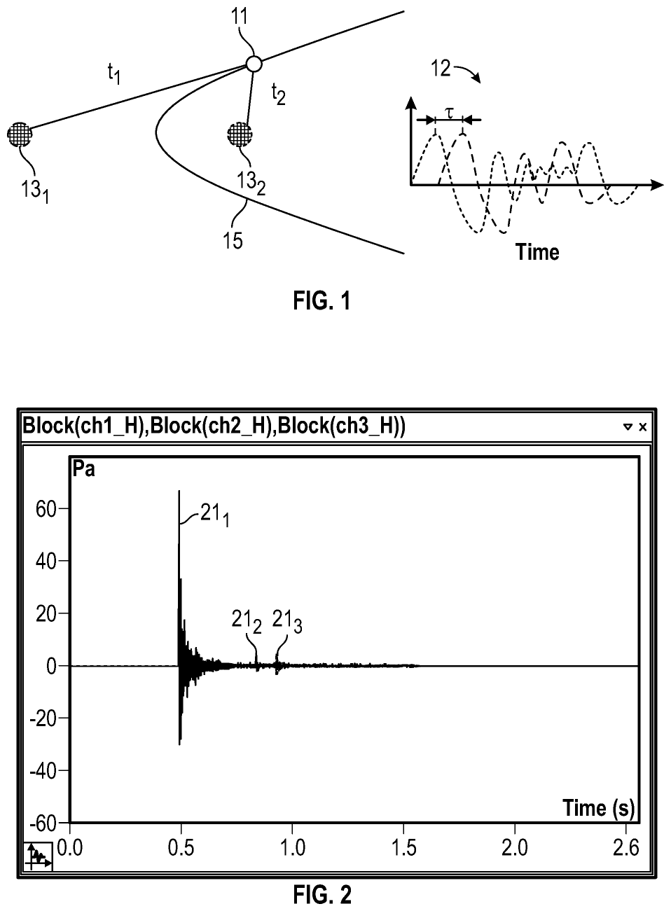

With reference to FIG. 1, the most classic algorithm to determine the location of the sound source (s) is based on the measured time delay. The principle at the heart of most acoustic localization algorithms, including accumulated correlation, is that the sound emitted by a sound source 11 will generally take a different amount of time to reach each microphone 13₁, 13₂, . . . in an array. By measuring the time of arrival (or equivalently, time delay) of the signal 12 for each microphone, the location of the sound source 11 can be determined. Consider the case when just a pair of microphones are available. The sound source will reach one microphone 13₁ at time t₁ and another microphone 13₂ at time t₂. The relative time delay τ=t₁−t₂ can be estimated by selecting the peak of the cross-correlation vector between the two microphone signals 12. If τ is correctly estimated, then the sound source must lie at a point in space such that t₁−t₂=τ, which defines one half of a hyperboloid 15. While idealized as perfect hyperboloids of zero thickness, the potential locations will have a width that depends upon the timing accuracy of the measured sound signals (the delay time t₁−t₂=τ, will in fact be τ±ε, where ε corresponds to the time stamping accuracy). Combining half hyperboloids of potential source locations from multiple pairs of data acquisition units, the hyperboloids will overlap at the actual sound source location within a spatial tolerance dependent upon the accuracy of time stamps for the sampled acoustic data. The better the accuracy, the more closely the sound source can be localized. Using 3 or more measurement points the coordinate of sound source can be established on a 2-dimensional (2D) plane; using 4 or more measurement points the location of sound source can be established in the 3-dimensional (3D) space. In a real application, the determination of the location of source can be more complex because the speed of the sound is not constant. Many factors, the temperature, humidity, density of the air, or wind will have impact to the speed of sound. The positions of microphones also play a big role in the accuracy of the source location estimation. When more DAQs are added into the whole measurement system, various statistical tools, such as minimum mean square error method can be used to estimate the best guess of the location of sound source. Cross-correlation function is an ideal tool to estimate the time delay between two time-domain signals. The concept of correlation in general quantifies the similarity of two time-dependent signals x(t) and y(t). The main property of correlation is that both signals do not have to depend on each other; only statements regarding their similarity can be given. The correlation of two time-dependent signals x(t) and y(t) is defined as

r_{xy}(τ)=∫_{-∞}^{∞}x(t)·y(t−τ)dt

The correlation function r_{xy}(τ) quantifies the conformity of x(t) compared to a time-shifted signal y(t−τ). The variable t contains the temporal distance between both signals. The higher the value of the correlation function, the more similar are both signals to each other. After the cross-correlation function between two signals is calculated, using peak or edge detection, the time delay between two signals can be determined.

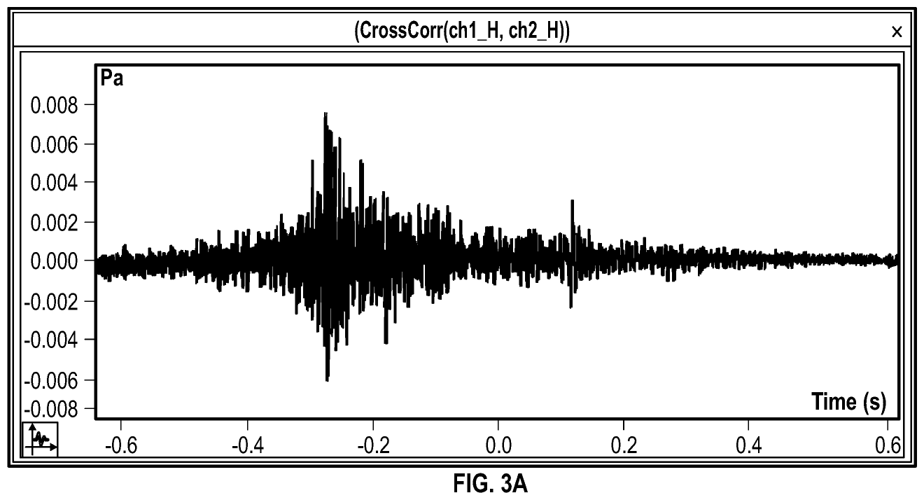

The data plot in FIG. 2 shows three recorded sound waveforms 211, 212, 213, from one single gunfire. There are three main transient events, one very large, two very small. The one with large peak 211 is from a microphone near the source of gunfire.

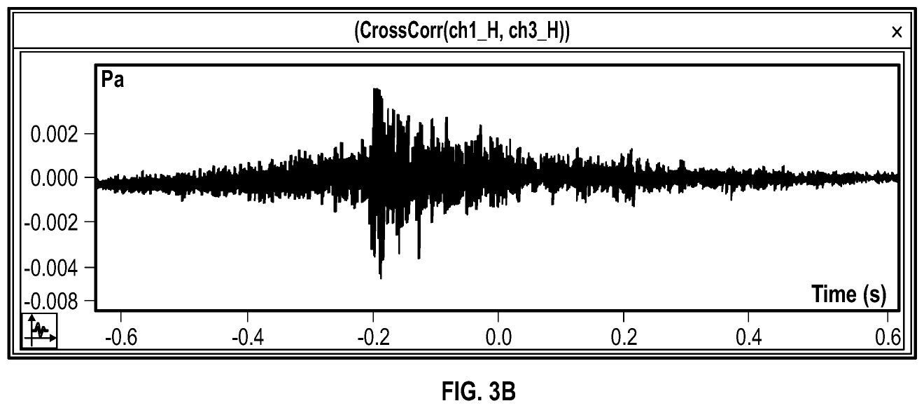

The data plots in FIGS. 3A, 3B and 3C show the three cross-correlation functions computed from each pair of sound waveforms. FIG. 3A is the cross-correlation from channels 1 and 2, FIG. 3B is the cross-correlation from channels 1 and 3, and FIG. 3C is the cross-correlation from channels 2 and 3. The peak location vs. origin 0.0 in the horizontal axis is the delay time τ that we try to detect. The delay time τ can be positive or negative. A positive value (as in FIG. 3C) indicates that the arrival time of x(t) (in this case, at sensor channel 2) is ahead of y(t) (at sensor channel 3), while a negative value of peak location (as in FIGS. 3A and 3B) indicates the opposite.

There is a direct transform relationship between the cross-spectrum G_{xy}(f) and the correlation function:

G_{xy}(f)=F(r_{xy}(τ)); and

r_{xy}(t)=F⁻¹(G_{xy}(f),

where F( ) is the Fourier transform and F⁻¹( ) is the inverse Fourier transform. While the correlation function can be obtained in the time domain by integral operation, there is an advantage to computing it first in the frequency domain through cross-spectrum and then transform it back to the time domain to generate the correlation function. This is because in the frequency domain, there are more tools to remove the noise, i.e., unwanted signals. For example, if a gunshot happens in a very noisy environment when a loud machine is running, or an airplane, a helicopter is approaching, the gunshot signal can be submerged in the noise. In the signal processing theory, noise refers to unwanted signals. Noise can be louder than the signal of interest.

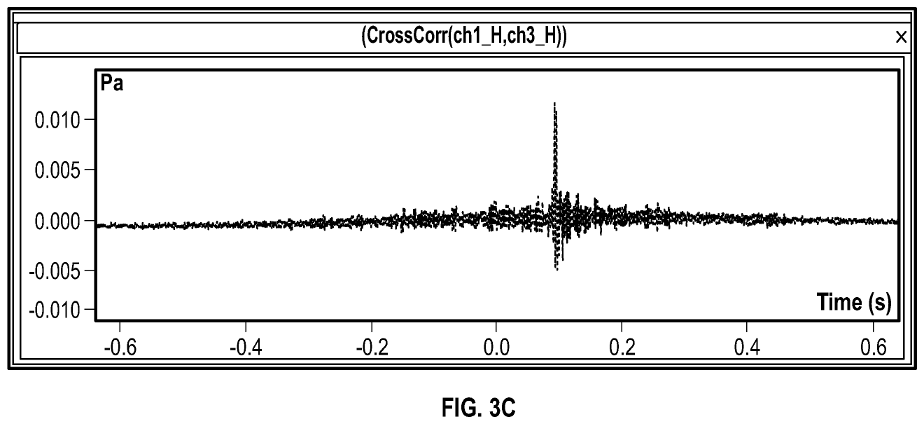

In a concept plot, FIG. 4, one curve 41 indicates the periodic signal coming from a loud machine, while the other, more transient, curve 42 is the gunshot signal. In time domain processing, it is very difficult to distinguish the gunfire event 42 from other, unwanted, signals 41. This is the root cause that some of the gunfire detection methods having very high false alarm rates.

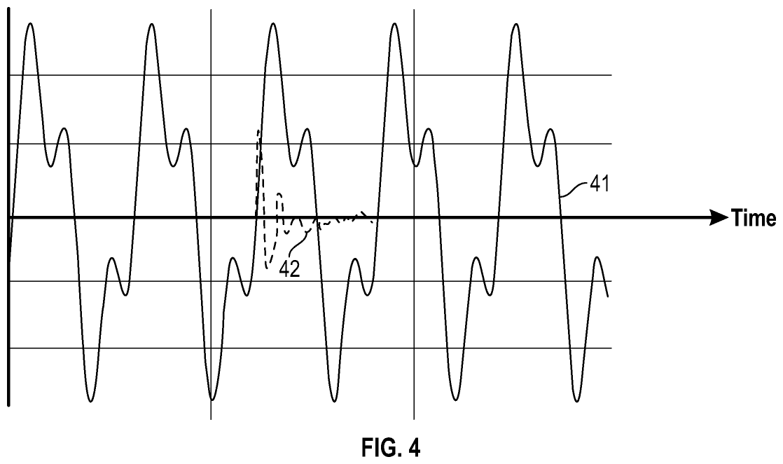

However, in the frequency domain, seen in FIG. 5, the cross-spectrum will exhibit following phenomena. In the cross-spectrum 51, the unwanted machine noise will show sharp peaks 53 at a series of harmonic frequencies. The gunshot signal 55 will show a few lumps at lower amplitude. In this case, an algorithm can be developed to filter out the harmonic peaks 53. Once these unwanted signals are taken out, the cross-spectrum signal can be transferred back to correlation function in the time domain where time delay is then computed.

Another distinct advantage conducted in the cross-spectrum domain is its capability of reducing the noise by applying the average. Multiple frames of cross-spectrum can be averaged to achieve higher confidence in the estimation. The rule of thumb is that the variance of estimation of source location can be increased by a factor of square-root of average number. For example, an average of 4 frames of data can reduce the variance by a factor of 2.

The cross-correlation function calculation, or any cross-term spectrum calculation, requires that all signals in the computation are digitized simultaneously. We have not found any existing technology that can easily compute the cross-correlation function or cross-spectra if the digitized signals are coming from ADCs driven by different sampling clocks, as is the case when multiple unconnected DAQs are involved. When cross-correlation function cannot be computed, people must use time domain methods for each individual sensor to compute the time delays between them. Various edge detection and peak detection methods are developed based on the envelope of time domain signals. Various statistics methods are developed to increase the accuracy of estimation. All these methods lack the advantage of those in the frequency domain mentioned above.

Regardless of whether cross-correlation techniques are used or not, the basic principle of estimating the location of sound source require input parameters of speed of sound, the locations of microphones and the measured time delay between all pairs of the microphones in use.

### Hardware Architecture

In U.S. Patent Application Publications 2022/0322259 and 2022/0322260, “Sampling Synchronization through GPS Signals”, a hardware-based method is disclosed to time stamp the digitized data after the ADC transforms the analog data into digital domain. In my pending U.S. patent application Ser. No. 17/564,654, a hardware and software solution are disclosed that the cross-spectrum can be computed based on such time stamped signals. The present invention will discuss further development in this domain that can be targeted at identifying the sound source location.

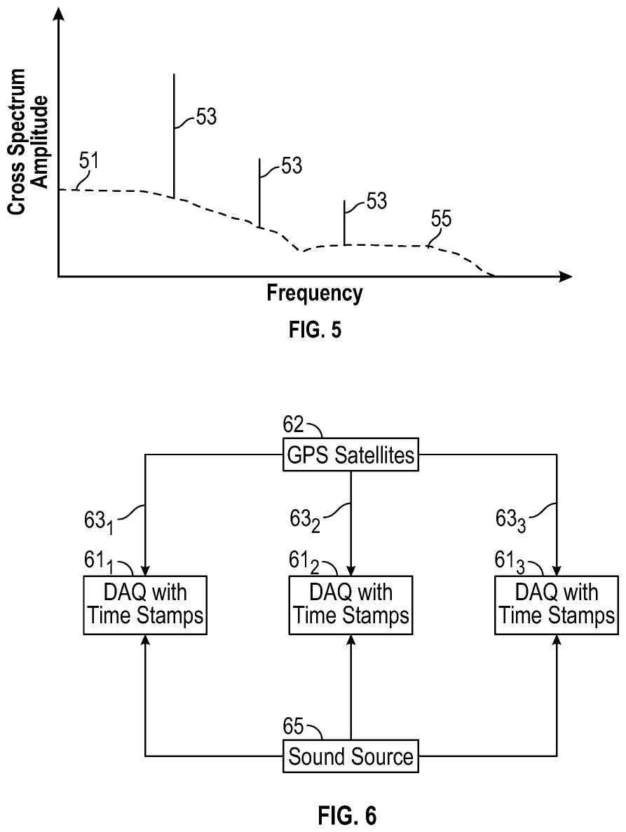

With reference to FIG. 6, a general architecture of the measurement system will comprise, at minimum, three DAQs 61₁, 61₂, 61₃ that can receive GPS signals 63₁, 63₂, 63₃ from one or more satellites 62 and sample acoustic signals from a sound source 65. A complete measurement system will consist of at minimum three DAQ units that take the measurements on a 2D plane. If the scope of interest involves a 3D space, then the minimum number of DAQ units becomes four. The distances between the several DAQ units can be as close as a few meters or as long as thousands of kilometers, depending on the application. For locating gunshot, typically the DAQ units should be installed a few hundred meters away from each other. The DAQ units can also be portable, wearable, and movable. Solders, police officers or security personnel can carry the DAQ individually. Although we mainly address the use of GPS as time sources 62, other traditional time sources, such as IRIG-B, can be used in the same way as the GPS time source.

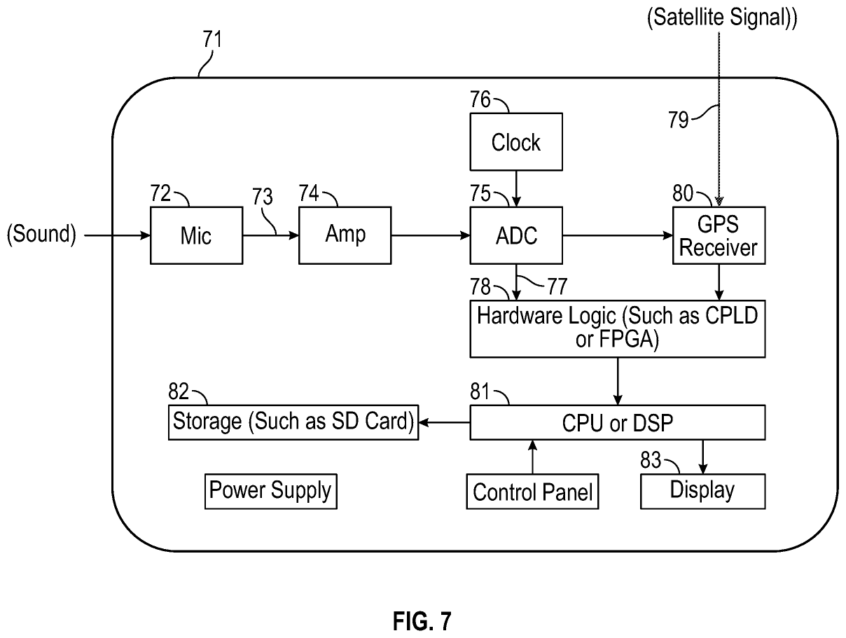

With reference to FIG. 7, each DAQ unit 71 will consist following hardware elements: one or multiple microphones 72 will be connected to each of the signal paths 73 in the DAQ system. Each signal path will comprise signal conditioning circuitry including a series of amplifiers 74. The output of the amplifier 74 will be fed into an analog-to-digital converter (ADC) 75. Each ADC 75 will be driven by a sampling clock 76, normally shared by all the ADCs in the same DAQ unit 71. The output 77 of the ADC 75, a stream of data in digital format, will be fed into digital circuitry 78, such as a FPGA (Field Programmable Gated Array) or CPLD (Complex Programmable Logic Device), and stored in a measurement data buffer. In parallel, the time source 79 of the DAQ system 71, is obtained by a GPS receiver 80 or any similar receiver of transmitted messages from a satellite radio beacon positioning system. The GPS receiver 80 is connected to an antenna that can sense the radio wave 79 from the GPS satellites. The receiver derives both unit position and time reference information from the satellite messages. A register on the GPS receiver 80 is accessible by the FPGA/CPLD 78 with deterministic timing, meaning the time read by the FPGA 78 has a fixed delay that is completely predictable within a few nanoseconds' uncertainty. When the measurement data buffer containing the data from the ADC 77 is full, the FPGA 78 shall read the corresponding time from the register of GPS receiver 80. This is how the time stamp is obtained. This time stamp will be stored in the FPGA 78. A CPU or DSP processor 81 will be able to read the data buffer from the FPGA 80 and the corresponding time stamp also stored in the FPGA 80. Now, a stream of time stamps is associated with a stream of measurement data at the CPU level. The measurement data and time stamps managed by CPU 81 can then be displayed by display hardware 83, or recorded into the storage device 82, such as an SD card.

Each DAQ unit 71 can be as large as a brick or as small as a mobile phone. In fact, if a mobile phone is customized with the time stamping function described below, it is an ideal solution as a wearable DAQ that solders can use in the field.

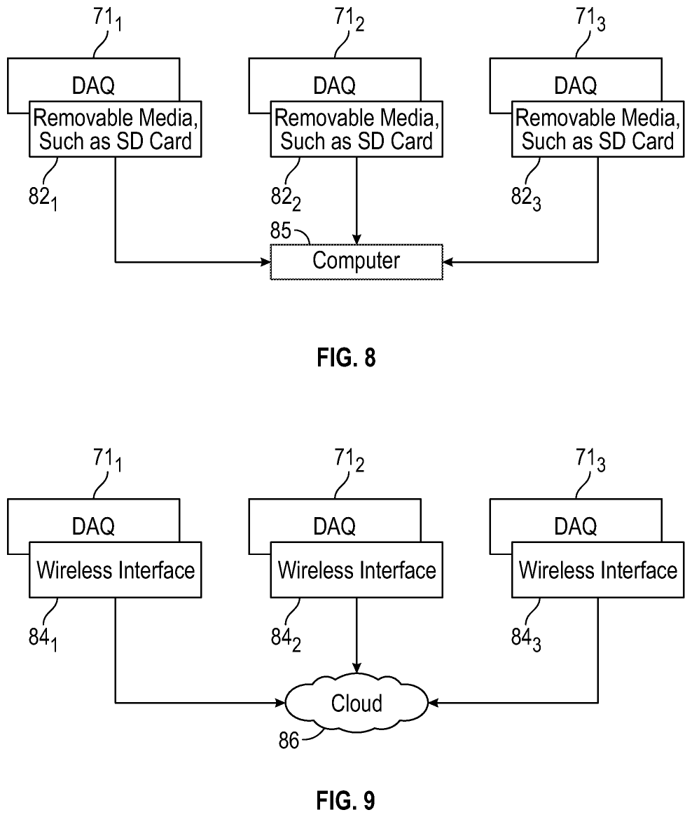

After the measurement data and their corresponding time stamps are obtained, they will be saved in the storage media 82 on each of DAQ systems 71. Since the cross-term calculation asks for the data from multiple devices, the measurement data must be gathered to a central location to conduct the calculation. The first method, represented by FIG. 8, is simply by manually remove the storage media 82₁, 82₂, 82₃ from each DAQ unit 71₁, 71₂, 71₃ and move it to a computer 85, download all the saved files and start the post processing. Alternatively, the data can be transmitted, as represented in FIG. 9, through USB, Ethernet, or other data ports to the central computer. If all the DAQ systems 71₁, 71₂, 71₃ are equipped with certain wireless interfaces 84₁, 84₂, 84₃, such as 4G LTE, 5G, or even low speed radio transmission methods, the measurement data and their corresponding time stamps can be transmitted wirelessly to a central server or the “cloud” 86. The post processing can be conducted on the cloud 86.

### Data Processing

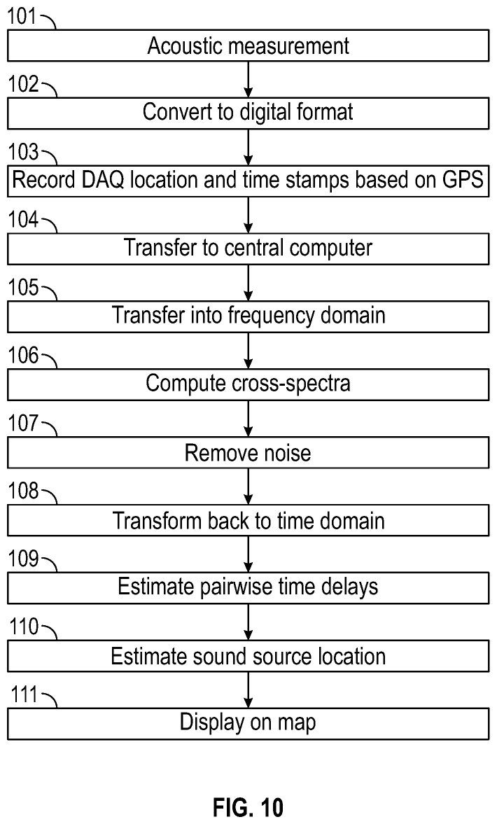

With reference to FIG. 10, the data processing steps begin with acoustic measurement 101, in which microphones sense and measure analog sound signals. There may be multiple microphones associated with each DAQ unit and, as has already been noted, multiple DAQ units distributed over an area of interest. Analog-to-digital converters (ADCs) in each sensor channel of each DAQ unit sample and convert 102 the analog sound signals into digital format. Concurrently, but not necessarily at the same rate, each DAQ location is recorded, and the digital signals are time stamped 103 based on GPS or a similar positioning/time reference. (Each DAQ unit is equipped with a GPS receiver or its equivalent.) The digital signals along with the associated time stamp and recorded DAQ location (s) are then transferred 104 to a central computer or cloud server. (As previously mentioned, this can be done manually via a removable SD card or equivalent storage media or done by wired or wireless data transmission.)

The next processing steps are done at the central computer (or in the cloud). Each of the digital signals is first transformed into the frequency domain 105. Then cross-spectra are computed 106 for multiple pairs of those transformed signals. Additionally, in the frequency domain processing 107 (filtering, averaging, etc.) can be performed to remove noise. The cross-spectra for each signal pair are then transformed 108 back to the time domain. In the time domain, the time delays between the multiple pairs of measurements can be estimated 109, and from those time delays and the respective DAQ positions the sound source is localized 110. Finally, the sound source location can be displayed 111 on a map, or the location coordinates otherwise communicated to the interested users.

### Time Stamping of Signals

In U.S. Patent Application Publications 2022/0322259 and 2022/0322260, the present inventor disclosed a method to accurately apply time stamps to the digital signals that come from each ADC in each DAQ unit. The source of the time base comes from a GPS receiver (or for a similar satellite system) or equivalent time sources, such as IRIG-B. A time register is configured in a FPGA or CPLD. When a buffer of the data is full (in the FPGA or CPLD), the hardware automatically transfers the value of this time register to a location where the processor can read. The value in this register is the time stamp corresponding to the last point in the data buffer. Since the whole process is deterministic in timing, the accuracy of time stamps is guaranteed to the 100 ns or better.

The sampling interval, dT, is the inverse of the sampling frequency of ADC. It is driven by an onboard clock on the DAQ unit. For example, assuming the nominal sampling frequency to be 100 kHz, the sampling interval dT will be 1/(100,000 Hz)=10 μs. 1% of sampling interval will be 100 ns. Since the sampling clock has a small drift, usually it is less than 50 ppm, the sampling interval may slight change over time. For example, it may change from 10 μs to 10.00001 μs, or to 9.999999 μs. When the sampling intervals on different DAQ drifted around, the exact sampling time (i.e., the ADC conversion time) will not line up to each other. However, it is possible to extract the time of each ADC conversion time, this is called time stamp.

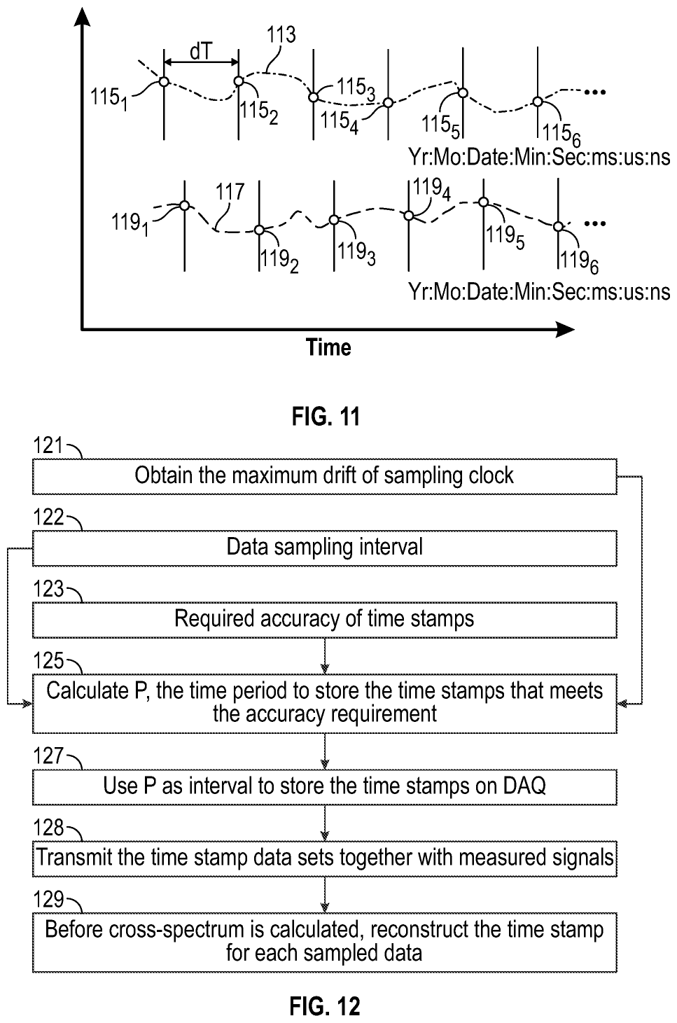

FIG. 11 shows conceptually how the time stamps are extracted and recorded for two series of digital signals. The curves 113 and 117 represent to analog acoustic signals that are digitized into respective series 115₁, 115₂, 115₃, . . . and 119₁, 119₂, 119₃, . . . . The vertical lines indicate the exact conversion time at which each ADC operates. The sampling interval dT is shown on the top left. Each small dot shows a sampled digital value after the ADC conversion. The time stamp is usually expressed in the absolute UTC format such as
yyyy:month:date:hours:minutes:seconds:ms:us:ns
   The issue is how accurate the time stamps must be for the application of acoustic source identification. According to the detail research in the cross-spectral domain and practical comparison, we determined that the time stamp accuracy must be better than roughly 10% of the sampling interval, and preferably better than 1% of the sampling interval. Following this guideline, the cross-spectrum can be accurately computed and averaged. The most typical sampling rate is 51.2 kHz for air acoustic signal measurement. The accuracy of time stamps then must be better than 2 μs, although as accurate as 200 ns is preferred. For underwater application, the sampling rate can be higher or lower, depending on the sonar technology being chosen.

### How Often to Store the Time Stamps

In this applicant's pending U.S. patent application Ser. No. 17/564,654, it is mentioned that to compute the cross-spectra of measured signals, each point of the sampling data is time stamped. However, if we generate time stamps for each sampled data point right after the ADC conversion, and if all those time stamps are transmitted along with their measurement data, then the total data quantity will be tremendous. Take as an example that a signal is sampled at 51.2 kHz and the time stamp is stored in the UTC format, which will take roughly 128 bits, i.e., 16 bytes per value. Every second it will take a memory space of 512000*16=8 Mbytes. One hour of recording will comes with 28 GB just to store the time stamps. The time stamp will take even more space than the actual measurement data. Not only it takes tremendous amount of space, but also the CPU computational resource to move around the data, not mentioning the speed or writing of them into the media like SD card. Obviously, this is not desirable.

Fortunately, we have determined that storing an original time stamp for each data sample is not necessary. A criterion can be established based on the maximum possible clock drift and nominal data sampling rate that time stamps can be stored at much longer period than the data sampling interval. In a typical acoustic frequency range, P, the period of storing the original time stamps can be as long as a few seconds to a few ten seconds. The stored time stamps will be interpolated or extrapolated to calculate the time stamp of each digital point right before the cross spectrum is computed. This strategy will significantly reduce the storage of original time stamps in the memory or in the storage media. In the example above when sampling rate is set to 51.2 kHz and P is 5 seconds, the data storage of time stamps will be reduced to 1/256000.

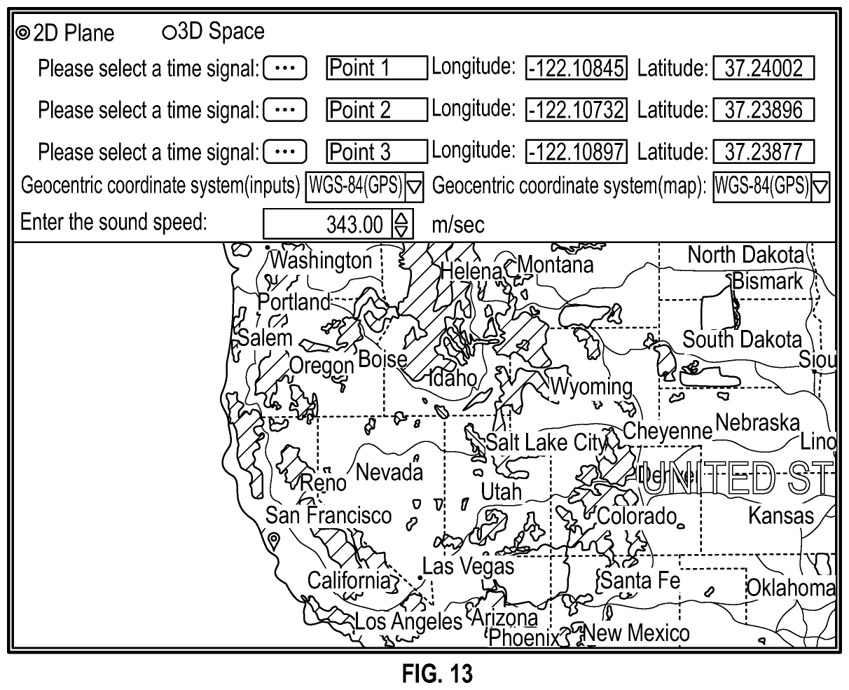

The flow chart in FIG. 12 shows the preferred time stamping process. To calculate 125 the frequency range P, we will need three input parameters. The maximum drift 121 of the clock is a hardware parameter usually specified in the data sheet. It is commonly defined in the unit of ppm, part per million. The 2nd parameter would be the sampling frequency 122 (i.e., the inverse of sampling interval). The 3rd parameter would be the required accuracy 123 of time stamps. In a typical example, the maximum drift of sampling clock is 50 ppm; the sampling frequency is 51.2 kHz with interval of 19.53125 μs; required accuracy of time stamp is 200 ns. With these inputs, statistically, we find that the P value is in the range of 5 to 50 seconds.

We use the calculated P value as the time stamping interval 127 for storing time stamps on the DAQ. Blocks of measurement data are transmitted 128 with their respective time stamps, one time stamp per block representing P seconds worth of sampled data. Then, before the cross-spectra are calculated, knowing the nominal data sampling rate and the time stamp for the last data sample in the block, one can reconstruct 129 (via simple interpolation) a corresponding time stamp for each data sample in that block.

Besides calculating P based on input parameters, we also can take measurement to verify if the selected interval P can generate accurate time stamps by comparing the reconstructed time stamps to those original. The goal is to store minimum number of original time stamps but can meet the accuracy requirement after the reconstruction. The reconstruction algorithm can be any simple interpolation algorithm like a two-point straight-line interpolation. For example, if two original time stamps are available for 5 seconds of measurement data sampled at 51.2 kHz, the time stamp of any of 256000 samples can be calculated.

The reduction in the size of time stamp signals described above plays a crucial role in our hardware architecture. When the DAQs are communicating to each other or to the cloud via wireless communication, the bandwidth is limited, and data rate can be low. While transmitting measurement data is all necessary, it would be highly desirable to make the size of time stamps as small as possible and transmit it with minimum resource. Hence the method described here is highly desirable.

### Signal Processing and Estimate of Sound Source Location

During the process of sound source identification, many known techniques of signal processing will be used, including envelope analysis, removing the background noise using either time or frequency domain methods, signature detection, determining the threshold of detection, loudness, and sharpness analysis, using redundant measurements to improve the accuracy of estimation, and so on. This invention focuses upon how to compute the cross-terms functions between any pair of measurement data sets using accurate time stamping technology. Once all the time delays are obtained using cross correlation functions, with known coordinate location of each DAQ, the source location can be estimated using methods described in the previous disclosures and textbooks.

The disclosed technology concerns multiple DAQ units that are separately distributed without hardwire connection in between. The accuracy of estimating the cross-spectrum and cross-correlation functions is as high as those obtained in a centralized data acquisition system with wired connection. Hence, the accuracy of estimation of the sound source location using the technology disclosed in this invention is the same as those from a centralized data acquisition system. The main factors influencing the accuracy of estimation will be no longer the instruments. Instead, other physical factors, such wind speed, become dominant factors.

### Maximum Cable Length of GPS Antenna

One of the drawbacks of GPS-based technology is that the DAQ must have access to the GPS satellite signals. We tested that the maximum usable length of cable for a GPS receiver antenna that is 50 meters. Beyond that, the time base accuracy is degraded sufficiently that cross-spectra calculations cannot be guaranteed.

### Display on a Map

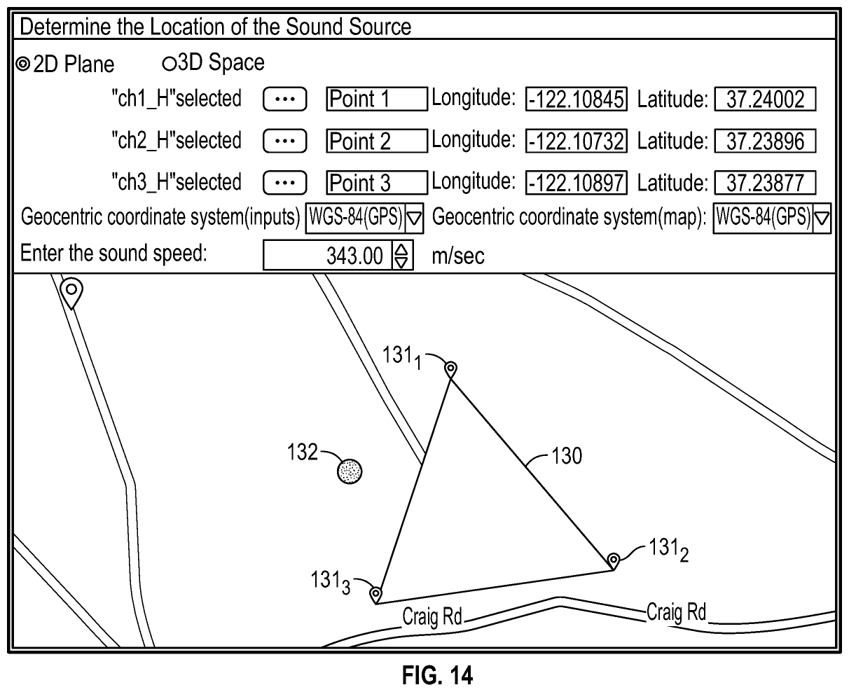

FIGS. 13 and 14 show a typical display of a sound source location on a map (which can be zoomed in or out as required). Coordinates of DAQ locations are also provided in, for example, longitude and latitude. If location in 3D space is required, then altitude of each DAQ location (of four units) and of the identified sound source can also be specified. The input and map coordinate systems need not be the same, provided any required conversions are made. As the location may depend also on the estimated sound speed in the location of the DAQ units, that variable might also be entered to see how it affects the determination of sound source location. In the more local map of FIG. 14, the three DAQ units form a triangle 130 with vertices 131₁, 131₂, 131₃ at their respective locations, while the dot 132 shows the calculated sound source location.

1. A sound source localization system, comprising:
multiple, physically unconnected, data acquisition units that are spatially distributed over an area of interest, each data acquisition unit having:
(a) at least one microphone capable of sensing and measuring sound to obtain analog sound signals,
(b) a receiver of transmitted messages from a satellite radio beacon positioning system, the receiver deriving position and time reference information from the messages,
(c) at least one analog-to-digital converter (ADC) associated with a corresponding microphone to sample the analog sound signals to obtain corresponding digital acoustic data, and
(d) a hardware logic circuit coupled to the ADC to receive the digital acoustic data therefrom and regularly time stamp batches of the digital acoustic data with a sub-microsecond accuracy relative to the time reference information derived from the receiver, and record a corresponding unit location from the position reference information derived by the receiver; and
a data processing location for receiving digital acoustic data along with the unit location and time stamping information from each data acquisition unit, the data processing location configured to:
(a) transform each of the digital acoustic data from each data acquisition unit from a time domain into a frequency domain to obtain a set of transformed acoustic signal data;
(b) compute cross-spectra for multiple pairs of the transformed acoustic signal data;
(c) transform the cross-spectra for each signal pair back into the time domain to obtain cross-correlation functions;
(d) estimate from the time-domain cross-correlation functions respective time delays of sensed acoustic events identified from the measured sound signals between each pair of data acquisition units; and
(e) determine a sound source location for each sensed acoustic event from the estimated time delays and recorded unit locations of each data acquisition unit pair.

2. The sound source localization system as in claim 1, wherein the multiple data acquisition units are distributed over at least one square kilometer and any pair of data acquisition units are separated from each other by distances greater than 100 meters.

3. The sound source localization system as in claim 1, wherein each data acquisition unit has a port for removable storage media storing the batches of the digital acoustic data along with the unit location and time stamping information, the removable storage media being transferrable to the data processing location.

4. The sound source localization system as in claim 1, wherein each data acquisition unit has a wireless interface for transmitting the batches of the digital acoustic data along with the unit location and time stamping information to the data processing location.

5. The sound source localization system as in claim 1, wherein the batches of the digital acoustic data are time stamped at intervals based upon a rate of maximum drift of a sampling clock for each analog-to-digital converter in each data acquisition unit, so that a corresponding time stamp for each sample of digital acoustic data in the batch is reconstructable within the sub-microsecond accuracy relative to the time reference.

6. The sound source localization system as in claim 5, wherein the accuracy of time stamps for each sample of digital acoustic data is guaranteed to 100 nanoseconds or better.

7. The sound source localization system as in claim 1, wherein the hardware logic circuit in each data acquisition unit is coupled to access a time register of the receiver.

8. The sound source localization system as in claim 1, wherein the data processing location is further configured to compute a bias correction based on a comparison of a measured time from a time stamp of the digital acoustic data with a corresponding nominal time based on a start time, nominal sampling rate of the clock, and number of data samples, and apply the computed bias correction to the timestamped data.

9. The sound source localization system as in claim 1, wherein the data processing location is further configured to filter and average the transformed acoustic signal data in the frequency domain to remove noise.

10. The sound source localization system as in claim 1, wherein the data processing location determines the sound source location of each sensed acoustic event from an overlap of half hyperboloids obtained from the estimated time delays from multiple pairs of data acquisition units.

11. The sound source localization system as in claim 1, wherein the data processing location determines the sound source location of each sensed acoustic event from statistical analysis of more than 3 estimated time delays from more than 3 pairs of data acquisition units.

12. A sound source localization method, comprising:
sensing and measuring sound with multiple microphones associated with multiple data acquisition units that are spatially distributed over an area of interest to obtain analog sound signals, the measured sound signals being sampled by analog-to-digital converters in each data acquisition unit to convert the measured analog sound signals into digital format to obtain corresponding digital acoustic data;
recording a unit location and accurately time stamping the digital acoustic data based upon a GPS positioning/time reference obtained by a GPS receiver in each data acquisition unit;
transferring the digital acoustic data along with the unit location and time stamping information from each data acquisition unit to a data processing location;
at the data processing location, transforming each of the digital acoustic data from each data acquisition unit from a time domain into a frequency domain to obtain a set of transformed acoustic signal data;
computing cross-spectra for multiple pairs of the transformed acoustic signal data;
transforming the cross-spectra for each signal pair back into the time domain to obtain cross-correlation functions;
estimating, from the time-domain cross-correlation functions, respective time delays of sensed acoustic events identified from the measured sound signals between each pair of data acquisition units; and
determining a sound source location for each sensed acoustic event from the estimated time delays and recorded unit locations of each data acquisition unit pair.

13. The method as in claim 12, wherein the time stamping of digital acoustic data is performed at a lower rate than a rate of sampling the sound signals.

14. The method as in claim 12, wherein the data processing location corresponds to a central computer.

15. The method as in claim 12, wherein the data processing location corresponds to a cloud server.

16. The method as in claim 12, wherein the transfer of digital acoustic data to the data processing location is done manually via a removable storage media.

17. The method as in claim 12, wherein the transfer of digital acoustic data to the data processing location is done by wireless data transmission.

18. The method as in claim 12, wherein the transfer of digital acoustic data to the data processing location is done by wired data transmission.

19. The method as in claim 12, wherein the transformed acoustic signal data is also filtered and averaged in the frequency domain to remove noise.

20. The method as in claim 12, further comprising displaying a determined sound source location for each sensed acoustic event on a map.

21. The method as in claim 12, further comprising communicating location coordinates of a determined sound source location for each sensed acoustic event.
